(19) United States
(12) Patent Application Publication
(10) Pub. No.: US 2024/0353291 A1
(43) Pub. Date: Oct. 24, 2024

(54) Device Diagnosis System

(71) Applicant: Hitachi Industrial Products, Ltd., Chiyoda-ku, Tokyo (JP)

(72) Inventors: Koichiro NAGATA, Tokyo (JP); Shigeyuki ABE, Tokyo (JP); Tatsuya MAEKAWA, Tokyo (JP)

(21) Appl. No.: 18/683,437

(22) PCT Filed: Aug. 31, 2022
(86) PCT No.: PCT/JP2022/032724

§ 371 Date: Feb. 13, 2024

(30) Foreign Application Priority Data
Sep. 21, 2021 (JP) 2021-153105

(51) Int. Cl. G01M 15/04; B60W 50/04; F02D 41/22

(52) U.S. Cl. CPC G01M 15/044; B60W 50/04; F02D 41/22

(57) ABSTRACT

It is not possible to easily divide an analysis process according to a torque or a speed change. A device diagnosis system comprises a threshold value arithmetic operation unit that uses a portion of time-series data measured during an operation of a device as reference data, and sets a plurality of threshold values with respect to the reference data, a data division unit that divides the time-series data that match conditions based on the plurality of threshold values as statuses of respective ranges, a feature arithmetic operation unit that calculates a feature (a basic static quantity) thereof from the time-series data in each status, and an abnormality degree arithmetic operation unit that uses another portion of the time-series data measured during the operation of the device as inspection data, and that analyzes and calculates an abnormality degree which is a degree of an abnormality of the inspection data for each status by using the feature with respect to the inspection data.

### TECHNICAL FIELD

The present invention relates to a device diagnosis system that diagnoses a state of a machine by collecting data from a device using a sensor and by analyzing the data, and more particularly to a device diagnosis system that divides processing that is an object to be analyzed at the time of performing an analysis.

### BACKGROUND ART

An industrial device system is constituted of some machines, and a product is manufactured through these machines. In the manufacturing, when a failure occurs in a machine, an operation is largely affected by a stop of the operation that is not scheduled thus giving rise to a drawback that a large loss in terms of cost occurs.

Accordingly, there has been adopted a technique where mechanical sensors that measure mechanical physical quantities such as the vibration of the machine, a pressure and the like and a temperature sensor are installed in each machine so as to collect machine data, and numerical values relating to a state of the machine are monitored by an analysis. Further, in a case where the machine is driven by a motor, there has been known a technique where electric data such as a motor current and the like are collected using electric sensors that measure electric physical quantities such as a current or a voltage, and a state of the machine is detected by analyzing the electric data. Further, also with respect to a moving body such as an automobile, a railway, an elevator or the like, there has been known a technique where electric physical quantities, mechanical physical quantities, and a temperature are measured. Further, a position of a moving body is measured.

In this manner, in performing a diagnosis of a machine using sensors, a state of the machine system is monitored, and in a case where there is a possibility that a failure occurs in the machine, the machine is repaired in advance thus preventing an unscheduled stop in advance.

For example, in patent literature 1, there has been proposed a technique where time-series data is grasped as feature data, threshold values are decided with respect to the feature data, and raw data is divided using peaks that exceed the threshold values as initiation points, and a process is divided for every plurality of peaks.

### CITATION LIST

### Patent Literature

Patent Literature 1: Japanese Unexamined Patent Application Publication No. 2020-135808

### SUMMARY OF INVENTION

### Technical Problem

For example, in a machine that performs operations such as making, unloading, loading and the like of a product, there is a case where an operation pattern of a machine such as a consumption torque, electric power, a speed and the like changes time sequentially. In analyzing the obtained data for performing monitoring of a state of such a machine, by dividing an operation pattern into processes that are uniform as much as possible, parameters that can be analyzed by the analysis become more apparent. However, in a case where such division is performed manually, there arises a drawback that time and efforts that an operator requires are increased.

Further, in case of the technique disclosed in patent literature 1, although a cyclic operation pattern can be divided, the technique does not cope with a case where a torque, a speed or the like changes depending on an operation pattern. Accordingly, in a case where a torque, a speed or the like changes, time and efforts are additionally required to divide the process for such a change.

In this manner, the prior art has a drawback that an analysis process cannot be simply divided corresponding to a change in a torque, a speed or the like.

### Solution to Problem

In view of the above, according to the present invention, there is provided a device diagnosis system that includes: a threshold value arithmetic operation unit that uses a portion of time-series data measured during an operation of a device as reference data, and sets a plurality of threshold values with respect to the reference data; a data division unit that divides the time-series data that match conditions based on the plurality of threshold values as statuses of respective ranges; a feature arithmetic operation unit that calculates a feature (a basic static quantity) thereof from the time-series data in each status; and an abnormality degree arithmetic operation unit that uses another portion of the time-series data measured during the operation of the device as inspection data, and that analyzes and calculates an abnormality degree which is a degree of an abnormality of the inspection data for each status by using the feature with respect to the inspection data.

### Advantageous Effects of Invention

According to the present invention, in the device diagnosis system, in analyzing the time-series data, time and efforts required at the time of dividing the time-series data for every process corresponding to a change in a torque, electric power, a speed or the like can be reduced. As a result, the present invention can acquire an advantageous effect that an operation time and a personnel cost can be reduced.

### BRIEF DESCRIPTION OF DRAWINGS

FIG. 1 is a constitutional view of a device diagnosis system according to an embodiment 1.

FIG. 2 is a conceptual view of the embodiment 1.

FIG. 3 is a conceptual view relating to data division and data selection in an embodiment 2.

FIG. 4 is a view relating to data selection in the embodiment 2.

FIG. 5 is a view relating to time-series data and its division in an embodiment 3.

FIG. 6 is a constitutional view of a device diagnosis system according to an embodiment 4.

### DESCRIPTION OF EMBODIMENTS

Hereinafter, embodiments of the present invention are described with reference to drawings.

### Embodiment 1

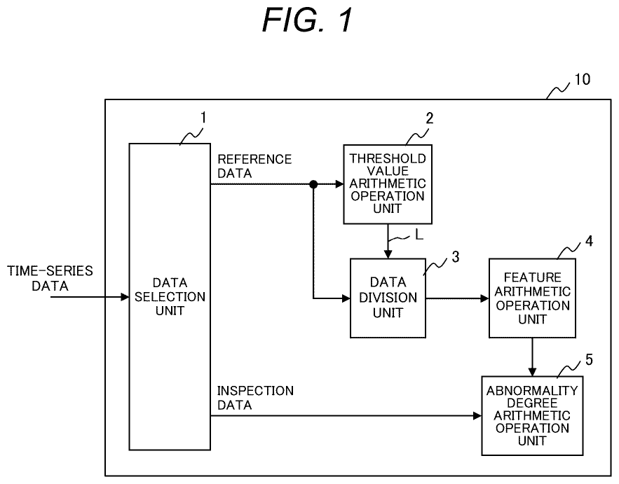

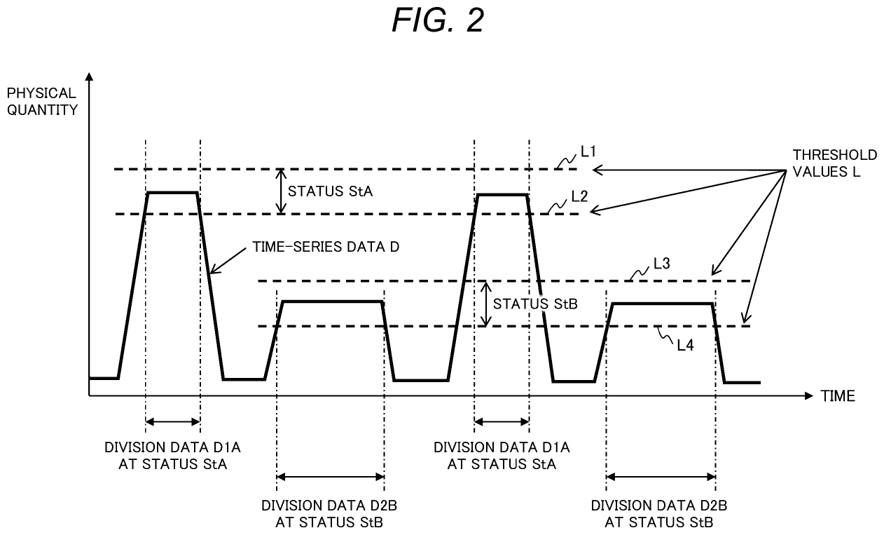

As an embodiment 1, a device diagnosis system that is applied to an industrial device is described with reference to FIG. 1 and FIG. 2. FIG. 1 illustrates a constitutional example of a device diagnosis system according to the embodiment 1 of the present invention. FIG. 2 is a conceptual view illustrating a concept of the present invention.

Time-series data D that is measured with respect to a device to be diagnosed is inputted to a data selection unit 1 of the device diagnosis system 10 in FIG. 1. In the data selection unit 1, a portion of the inputted time-series data D is set or used as reference data, and another portion of the inputted time-series data D is set or used as inspection data.

FIG. 2 illustrates a case where time is taken on an axis of abscissas and a measurement object physical quantity is taken on an axis of ordinate, and the time-series data D of the measurement object physical quantity changes repeatedly in order of a high value, a low value and an intermediate value. With respect to the time-series data D, in a threshold value arithmetic operation unit 2 illustrated in FIG. 1, L1, L2, L3, L4 (L1>L2>L3>L4) are set as threshold values L, and a value of a physical quantity within a range of two sets of threshold values decided by these threshold values is extracted as reference data DI by a data division unit 3. In the case illustrated in FIG. 2, four sets of threshold values are set, the time-series data of an amount between the threshold values L1 and L2 is divided as first reference data D1A (division data of a status StA), while the time-series data of an amount between the threshold values L3 and L4 is divided as second reference data D2A (division data of a status StB). The division data of the status StA is obtained by extracting the high value of the time-series data D as the reference data, and the division data of the status StB is obtained by extracting an intermediate value of the time-series data D as the reference data.

In this manner, the threshold values are decided by the threshold value arithmetic operation unit 2 such that portions of the time-series data D form the reference data D1. In such processing, the threshold values are set such that the time-series data D falls between two threshold values (for example, L1 and L2). With such processing, the time-series data D is divided such that the time-series data D match within a certain range.

Further, in the data division unit 3, the data is divided using intersecting points between the threshold values (for example, L1 and L2) and the time-series data D. Further, in the data division unit 3, the data to be analyzed is selected and the selected data is transmitted to a feature arithmetic operation unit 4.

As illustrated in FIG. 2, with respect to the time-series data D where a certain physical quantity transitions with time, in the threshold arithmetic operation unit 2, the threshold values L (L1, L2, L3, L4) that are parallel to the time axis as indicated by a broken line are set such that the ranges in each of which the time-series data is sandwiched are decided. Then, by vertically drawing the intersecting point between the threshold value and the time-series data as indicated by a chain line, the time-series data is divided.

Subsequently, in FIG. 1, with respect to the reference data D1 that are obtained by division and are distributed for the respective statuses, a feature is decided for the respective statuses (for example, the statuses at the high value and the intermediate value in the case illustrated in FIG. 2) by the feature arithmetic operation unit 4. It must be noted that the features that is calculated by the feature arithmetic operation unit 4 is a basic statistical value such as an average value, a maximum value, a minimum value, a variance value, a standard deviation or the like.

On the other hand, a portion of the time-series data D is set or used as inspection data D2, and abnormality degree of the inspection data D2 is calculated by an abnormality degree arithmetic operation unit 5 using the inspection data D2 and the above-mentioned feature. The inspection data D2 may be data at any point of time of the time-series change illustrated in FIG. 2. In calculating the abnormality degree, the abnormality degree is calculated based on a statistical distance between the above-mentioned reference data D1 and the above-mentioned inspection data D2 (generally referred to as Mahalanobis' distance). More specifically, in the feature arithmetic operation unit 4, a feature is calculated from the reference data D1, and a difference (statistical distance) between the feature and the inspection data D2 is set as abnormality degree.

This embodiment is applicable to a machine whose load changes during an operation such as a machine that performs a ground digging operation, a machine that performs a water discharging operation by a pump, a machine that performs a non-periodic load change operation and the like in such a manner that the time-series data of the machine in such operations can be easily divided for respective similar states (processes). Further, by analyzing the time-series data that is substantially equal to the divided data, the transition of the state of the machine can be observed.

In the configuration illustrated in FIG. 1, the reference data and the inspection data are different physical quantities from each other. The feature is inspected from the time-series data when the time-series data is divided with respect to the first physical quantity for respective statuses. On the other hand, the time-series data during a period of the same status with respect to the second physical quantity is set as the inspection data, and the feature and the time-series data of the second physical quantity during the period of the same status that is used as the inspection data are compared with each other by abnormality degree arithmetic operation unit thus performing a mutually correlative diagnosis.

### Embodiment 2

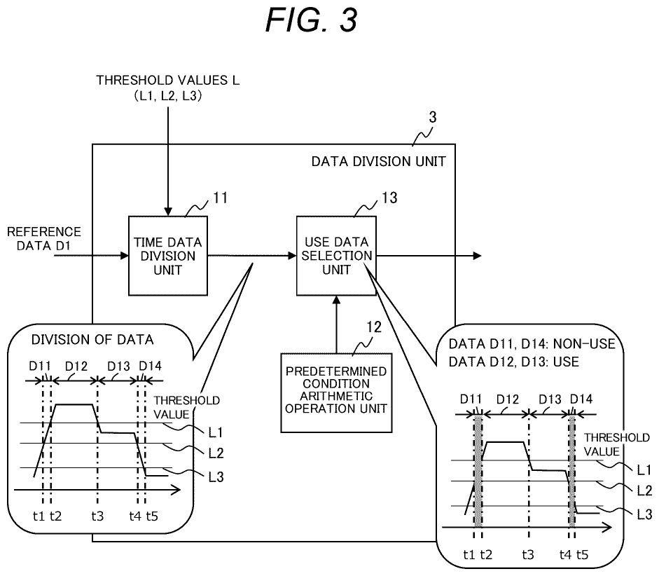

As an embodiment 2, a device diagnosis system that is applied to an industrial device is described with reference to FIG. 3. The points which make the embodiment 2 differ from the embodiment 1 are described. In FIG. 3, the selection of analyzed data in a data division unit 3 is illustrated. In the data division unit 3, data is divided at intersections between threshold values and reference data by a time data division unit 11.

In FIG. 3, the case is described where, using three threshold values L1, L2, L3 (L1>L2>L3), data D11 between points of time t1 and t2 and data D13 between points of time t4 and t5 when the time-series data is divided under a condition of L1 or less and L2 or more, data D12 between points of time t2 and t3 under a condition of L1 or more, and data D14 between points of time t3 and t4 under a condition of L2 or less and L3 or more are extracted as the reference data.

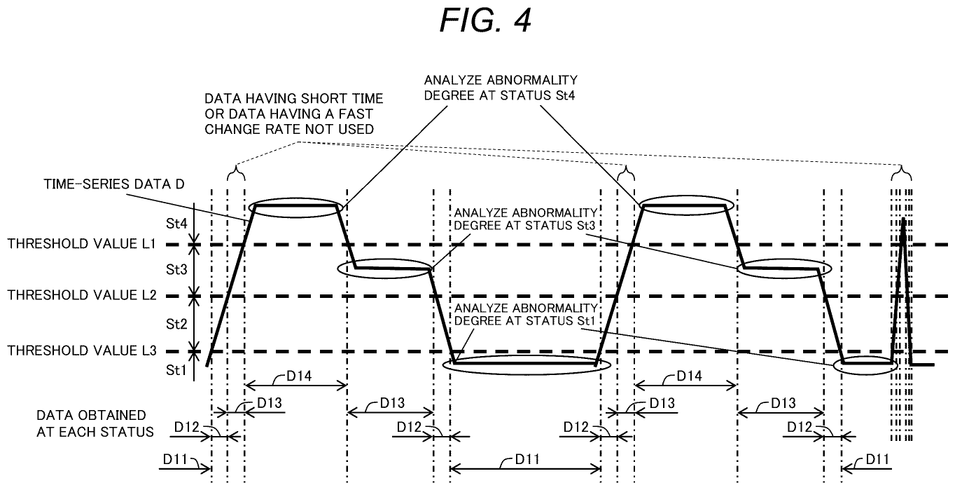

The divided data D11, D12, D13, D14 obtained by division performed by the time data division unit 11 illustrated in FIG. 3 are transmitted to a use data selection unit 13, and the data are selected as use data and non-use data in accordance with conditions from a predetermined condition arithmetic operation unit 12. Specific techniques for data division in the time data division unit 11, predetermined conditions obtained by the predetermined condition arithmetic operation unit 12, and the selection of data to be analyzed in the use data selection unit 13 are described with reference to FIG. 4.

In the case illustrated in FIG. 3, with respect to the divided data D11, D12, D13, D14, the use data selection unit 13, adopts D12, D13 as the use data, and decides D11, D14 as the non-use data. In this case, such decision is made by taking into account that the condition from the predetermined condition arithmetic operation unit 12 is that, for example, a time length of the sampled data is a fixed time or more so that data having the short sample time is data in a transitional state whereby the data is inappropriate for obtaining a feature.

FIG. 4 is a view illustrating the division and selection techniques with respect to time-series data in the present embodiment. In FIG. 4, in the time data division unit 11 illustrated in FIG. 3, three threshold values L (L1, L2, L3 (L1>L2>L3)) indicated by a bold dotted line are set with respect to the time-series data D indicated by a bold line, and the time-series data D is divided into processes for four respective statuses St (St1, St2, St3, St4) by drawing lines vertically (indicated by a chained line) from intersecting points between the time-series data D and the threshold values L (L1, L2, L3). At this stage of the operation, in a case where the reference data D pulsates, it is preferable to lower a pulsation component by using a moving average or a filter.

In this embodiment, the time-series data D is divided in such a manner that a region equal to or below the threshold value L1 is set as a status St1, a region between the threshold values L1, L2 is set as a status St2, a region between the threshold values L2 and L3 is set as a status St3, and a region equal to or below the threshold value L1 is set as a status St4. Data obtained in the respective statuses St are respectively expressed as D11, D12, D13, D14, and periods for sampling such data are described in a lower portion of FIG. 4.

Next, in a case where an arithmetic operation of abnormality degrees of the statuses St1, St3, St4 is desired, the predetermined condition arithmetic operation unit 12 illustrated in FIG. 3 sets the following predetermined condition, and data that does not conform with such condition is excluded from an analysis arithmetic operation in the use data selection unit 13.

For example, assume that the above-mentioned feature has a value corresponding to frequency, and frequency resolution at the time of discriminating the frequency is Δf. Δf is, for example, the frequency or less to 1/10 or less of the frequency. On the other hand, assuming that a time width of divided process data as Δt, the frequency resolution becomes 1/Δt. Accordingly, by setting the required frequency resolution Δf to satisfy Δf≤1/Δt, an analysis arithmetic operation is performed only with respect to data having a large Δt.

Further, in a case where an average change rate of the divided process data is equal to or less than a change rate of speed or a torque of a device in operation, a transitional phenomenon caused by acceleration of a machine is removed and excluded from an object to be analyzed.

Accordingly, rapid rising or rapid lowering in the time-series data or transitional phenomenon such as a peak on a right end of the time-series data illustrated in FIG. 4 can be removed from an object to be analyzed.

### Embodiment 3

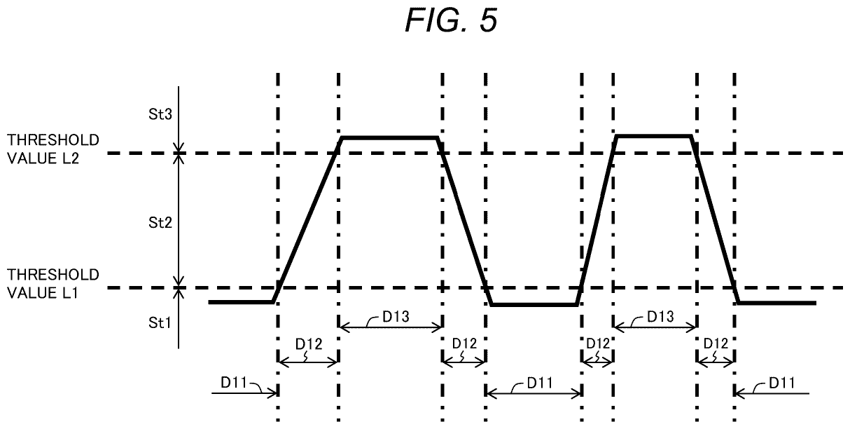

As an embodiment 3, a device diagnosis system that is applied to an industrial device is described with reference to FIG. 5. The points which make the embodiment 3 differ from the embodiment 1 and the embodiment 2 are described. FIG. 5 is a view illustrating time-series data having a most simple shape in change of the data, that is, the time-series data being constituted of only one high portion and one low portion.

In analyzing such data, as illustrated in FIG. 5, two threshold values L1, L2 are set so as to set regions close to a high portion and a low portion as status. With such setting, the statuses St1, St 2, St3 can be defined, a data analysis can be performed in the statuses St1 and St3, and a data analysis is not performed in the status St2. Accordingly, at least two threshold values are set so as to divide the time-series data into three statuses. In this embodiment, in a case that the time-series data changes, only the respective status data can be analyzed while excluding transitional states.

### Embodiment 4

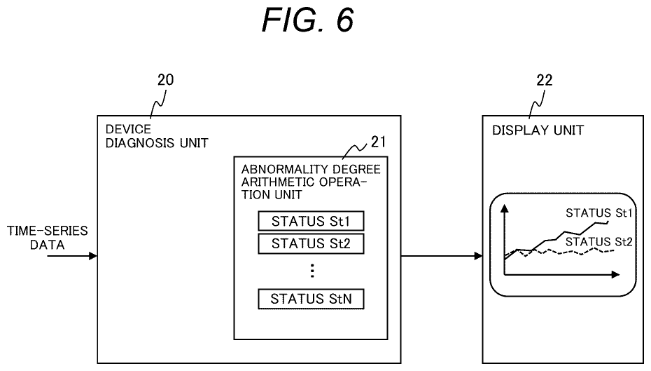

As an embodiment 4, a device diagnosis system that is applied to an industrial device is described with reference to FIG. 6. The points which make the embodiment 4 differ from the embodiment 1 to the embodiment 3 are described. FIG. 6 is a view that particularly illustrates a means that outputs an analysis result in a device diagnosis system that includes the present embodiment.

In FIG. 6, the device diagnosis system includes a device diagnosis unit 20 that diagnoses a state of a device such as the device illustrated in the embodiment 1, and calculates abnormality degree. The device diagnosis unit 20 divides time-series data D in the same manner as the embodiment 1, and includes an abnormality degree arithmetic operation unit 21 that calculates abnormality degree for respective statuses St. Abnormality degrees calculated for respective statuses are displayed by a display unit 22. In this embodiment, the calculated states (abnormality degrees) of the device are displayed and hence, an operator can grasp the state of the device. In displaying abnormality degree, a display disposed near the device diagnosis unit 20 may be used as a display unit 22, or a result of abnormality degree arithmetic operation may be transmitted to a remote place using in a wired manner or in a wireless manner.

### REFERENCE SIGNS LIST

1 . . . data selection unit
2 . . . threshold value arithmetic operation unit
3 . . . data division unit
4 . . . feature arithmetic operation unit
5 . . . abnormality degree arithmetic operation unit
11 . . . time data arithmetic operation unit
12 . . . predetermined condition arithmetic operation unit
13 . . . use data arithmetic operation unit
20 . . . device diagnosis unit
21 . . . abnormality degree arithmetic operation unit
22 . . . display unit

1. A device diagnosis system comprising:
a threshold value arithmetic operation unit that uses a portion of time-series data measured during an operation of a device as reference data, and sets a plurality of threshold values with respect to the reference data;
a data division unit that divides the time-series data that match conditions based on the plurality of threshold values as statuses of respective ranges;
a feature arithmetic operation unit that calculates a feature (a basic static quantity) thereof from the time-series data in each status; and
an abnormality degree arithmetic operation unit that uses another portion of the time-series data measured during the operation of the device as inspection data, and that analyzes and calculates an abnormality degree which is a degree of an abnormality of the inspection data for each status by using the feature with respect to the inspection data.

2. The device diagnosis system according to claim 1,
wherein the reference data and the inspection data are time-series data with respect to a same physical quantity that are measured during an operation of the device, and are obtained at different points of time.

3. The device diagnosis system according to claim 1,
wherein the data division unit includes:
a predetermined condition arithmetic operation unit that sets a predetermined condition to be used for calculating the feature;
a use data selection unit that excludes a status that does not satisfy the predetermined condition from a plurality of divided statuses.

4. The device diagnosis system according to claim 3,
wherein the feature has a value corresponding to a frequency, and the predetermined condition is a condition where, at the time of dividing the time-series data to processes, with respect to a time width Δt of the divided data, 1/Δt has a value smaller than a magnitude of the frequency desired to be detected at the feature.

5. The device diagnosis system according to claim 3,
wherein the predetermined condition is a condition that the divided time-series data is data where an average change rate at the divided time width is a predetermined value or less.

6. The device diagnosis system according to claim 5,
wherein the predetermined value of the average change rate is a value corresponding to a change rate of a speed or a torque of the device during the operation.

7. The device diagnosis system according to claim 1,
wherein in calculating the abnormality degree in the abnormality degree arithmetic operation unit, abnormality degree is calculated based on a statistical distance between the reference data and the inspection data.

8. The device diagnosis system according to claims 1,
wherein in dividing the time-series data into processes is from an intersecting point between the threshold value and the time-series data in the data division unit, in a case where the time-series data pulsates, a pulsation component is lowered by a moving average or a filter.

9. The device diagnosis system according to claim 1,
wherein the abnormality degree is measured for every statuses, and the measured abnormality degrees are outputted.
